(19) United States
(12) Patent Application Publication
(10) Pub. No.: US 2026/0252312 A1
(43) Pub. Date: Aug. 27, 2026

(54) STRUCTURED DATA STREAM PROCESSING

(71) Applicant: International Business Machines Corporation, Armonk, NY (US)

(72) Inventors: Manoj Kumar, Yorktown Heights, NY (US); Kattamuri Ekanadham, Mohegan Lake, NY (US); Jose E. Moreira, Irvington, NY (US); Pratap C. Pattnaik, Ossining, NY (US); Jessica Hui-Chun Tseng, Fremont, CA (US); Gianfranco Bilardi, YORKTOWN HEIGHTS, NY (US)

(21) Appl. No.: 19/060,877

(22) Filed: Feb. 24, 2025

(51) Int. Cl. G06F 7/57

(52) U.S. Cl. CPC G06F 7/57

(57) ABSTRACT

A present invention embodiment provides an operator unit (OPU) comprising an arithmetic logic unit (ALU) that is configured to natively process input tuples, an operator queue associated with the ALU, wherein the operator queue stores one or more operators for the ALU to execute on the input tuples, an operand buffer associated with the ALU, wherein the operand buffer stores the input tuples and provides the input tuples to the ALU for execution, and an output buffer configured to store output tuples generated by the ALU executing the one or more operators on the input tuples.

### BACKGROUND

### 1. Technical Field

Present invention embodiments relate to data processing systems, and more specifically, to systems for processing structured data streams.

### 2. Discussion of the Related Art

Conventional computing systems (e.g., systems that employ general-purpose processors) experience performance issues with regard to processing certain data types. For example, graph analytics, sparse matrix computations, and other data structures can exhibit poor locality of access, making caches inefficient and thereby causing long latencies for load and/or store operations because of frequent cache misses. While out-of-order processors may attempt to mask latency issues by executing other instructions while waiting on a load or store operation to complete, queue entries eventually fill up, causing the processor to stall.

### SUMMARY

According to one embodiment of the present invention, a system is provided for processing structured data streams. An operator unit (OPU) is provided comprising an arithmetic logic unit (ALU) that is configured to natively process input tuples, an operator queue associated with the ALU, wherein the operator queue stores one or more operators for the ALU to execute on the input tuples, an operand buffer associated with the ALU, wherein the operand buffer stores the input tuples and provides the input tuples to the ALU for execution, and an output buffer configured to store output tuples generated by the ALU executing the one or more operators on the input tuples. A method of using processing data using the OPU is also provided.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of application code according to an embodiment of the present invention.

FIG. 3 is a block diagram of an operator processing unit according to an embodiment of the present invention.

FIG. 4 is a block diagram of a memory system for an operator processing unit according to an embodiment of the present invention.

FIG. 5 is a block diagram of an operator processing unit system according to an embodiment of the present invention.

FIG. 6 is a block diagram of an operator processing unit system according to an embodiment of the present invention.

FIG. 7 is a flowchart of a method for processing data using an operator processing unit according to an embodiment of the present invention.

FIG. 8 is a flowchart of a method for executing a processing job using an operator processing unit system according to an embodiment of the present invention.

### DETAILED DESCRIPTION

A present invention embodiment relates to data processing systems, and more specifically, to systems for processing structured data streams. Conventional processors typically include hardware prefetchers that are optimized to seek linear access patterns. When a prefetcher identifies a pattern, the next block of memory can be fetched in advance. However, for sparse, indirect accesses, the access pattern can appear random. Since a fetcher or prefetcher cannot accurately determine where the next element will be, this causes frequent misses, forcing the processor to stall until the data is fetched. Thus, conventional processors are inefficient at processing data that presents a poor locality of access, such as sparse matrices or large graphs.

The embodiments presented herein address these problems by providing processing hardware that is optimized to process sparse data. In particular, sparse data is transformed into structured data streams, which are sequences of elements of a data structure arranged in a well-defined order. These data streams may be tuples of scalars, providing an organized and ordered sequence of the data to the hardware. Unlike conventional processors, which fetch instructions for every operation (even repeatedly-looping operations), and which fetch data in a fixed-sized amount (e.g., 64 bits at a time), the embodiments presented herein employ stream operator processing units that operate on variable-length streams of tuples and can repeatedly apply operators to data as the data becomes available. Moreover, the embodiments presented herein utilize specialized memory units that optimize the fetching and/or writing of variable-length streams.

Thus, present embodiments improve the technical field of computing by natively processing variable-length tuples using specialized logic that iteratively applies operators to data in hardware, reducing instruction overhead and enabling high-level commands to apply to entire data streams. Present invention embodiments provide several practical applications, including improving the efficiency of processing large, irregular datasets as compared to general-purpose processors by directly addressing problems presented by data having poor spatial locality. Additionally, multiple stream operator processing units can be connected together via local buses, improving memory access and execution as data can be efficiently cascaded from one unit to another to handle repeated use of streams. The embodiments presented herein also provide the practical application of offloading certain processing tasks from general processors, thus freeing the processors to perform other processing tasks.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

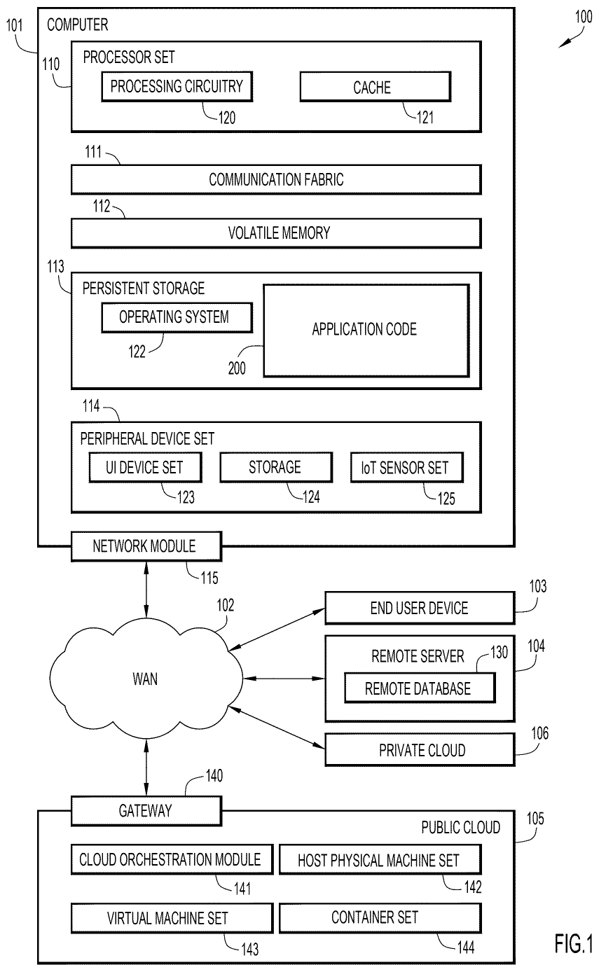

Referring to FIG. 1, computing environment 100 contains an example of an environment for the execution of at least some of the computer code involved in performing the inventive methods, such as application code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

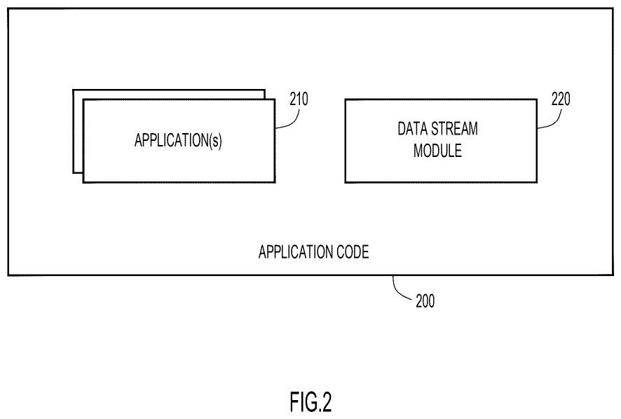

A block diagram of application code 200 according to an embodiment of the present invention is illustrated in FIG. 2. Specifically, application code 200 one or more applications 210, and a data stream module 220. Each application 210 and/or data stream module 220 may include one or more modules or units to perform various functions of present invention embodiments described herein. Each application 210 and/or data stream module 220 may be implemented by any combination of any quantity of software and/or hardware modules or units, and may reside within volatile memory 112 of computer 101 for execution by a processor, such as processor set 110. In particular, applications 210 may be mainly executed via processor set 110, with some operations being passed through data stream module 220 to be executed by one or more OPUs.

Application(s) 210 may include any software that is configured to be executed in a multiprocessor computing environment. Any of application(s) 210 may be configured to execute code in a computing system embodiment described herein that includes one or more operator processing units (OPUs) configured to process streaming tuples of data. The applications(s) 210 may utilize a general-purpose processor for some operations, and other operations may be provided to the one or more OPUs. In various embodiments, the decision logic for using a general-purpose processor versus an OPU may be implemented in software (e.g., in application(s) 210 and/or an operating system) or can be implemented in hardware. Thus, application(s) 210 may execute in an optimized manner in which operations suitable for processing by an OPU is processed by one or more OPUs, and/or other operations may be executed using other processors.

Data stream module 220 may generate structured data streams for processing in accordance with the embodiments presented herein. A data stream may include tuples of scalar values, which can be an ordered list of integer values, floating point values, and/or other scalar values. In some embodiments, data stream module 220 may generate a structured data stream by streaming out elements of a matrix in row-major order or column-major order. In some embodiments, a sparse matrix may be processed into three streams (e.g., as a compressed sparse row (CSR) format. The three streams generated from a sparse matrix may include a first stream of column-begin positions, a second stream of column numbers for the columns that have non-zero values, and a third stream of the actual values of the non-zero elements in those columns. Thus, the second and third stream in this example embodiment have a same number of tuples. For a given database, a stream can include a list of elements in a selected column or selected row.

In some embodiments, a graph (e.g., a directed acyclic graph) is processed into a data stream. In a graph data structure, a pointer refers to a link between two nodes (i.e., vertices). Thus, a stream of tuples can be generated that includes a list of pointers to all adjacent nodes of a graph node. Additionally or alternatively, a stream can include a list of <property, value>pairs of graph nodes. In some embodiments, an arbitrarily-complex set of operations can be decomposed by data stream module 220 into a directed acyclic graph in which each node represents a command from a library.

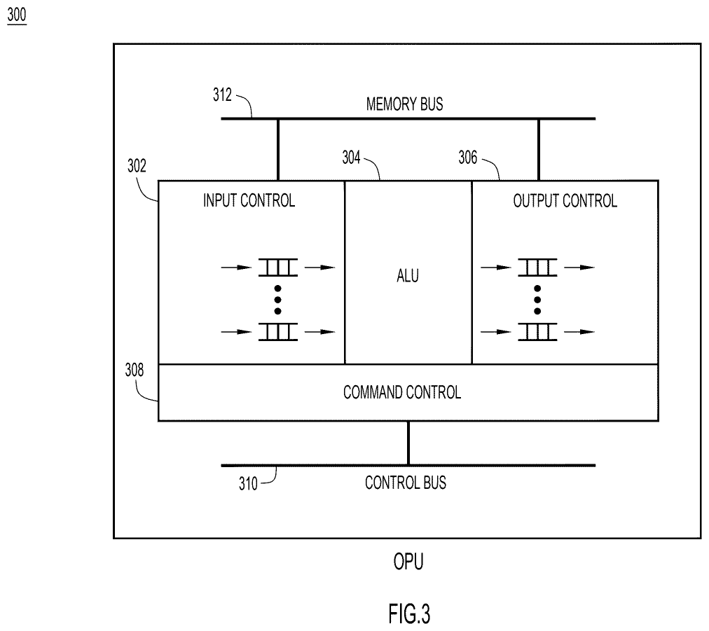

With reference now to FIG. 3, a block diagram is provided of an operator processing unit (OPU) 300 according to an embodiment of the present invention. As depicted, the OPU 300 includes an input control 302, an arithmetic logic unit (ALU) 304, an output control 306, a command control 308, a control bus 310, and a memory bus 312.

ALU 304 may perform arithmetic and logic operations on operands provided to the OPU 300. The operators that define operations to perform by the ALU 304 may be provided by command control 308, and the input operands may be obtained from input control 302. Output of the ALU 304 is provided to output control 306. ALU 304 may execute integer and/or float operations on operands provided to OPU 300. In particular, ALU 304 may process streams of tuples that are obtained from input control 302, which can fetch or prefetch stream data from memory (obtained via memory bus 312). Input control 302 may also handle indirect memory accesses via memory bus 312. The results of ALU 304 are provided to output control 306, which can accumulate results and/or send the resulting output streams to memory (e.g., via memory bus 312). Input control 302 may perform fetch operations, and output control 306 may perform store operations, and each of input control and output control 306 may include caches for storing input and output tuples, respectively. In some embodiments, output control 306 may send data directly to the input control of another OPU. OPU 300 may include accumulators (e.g., implemented in output control 306) in which partial results of calculations are stored to be combined with other input operands for further processing. The accumulators may perform some operations, including reductions (e.g., reducing elements into fewer results or one result) and/or point-wise operations. A same instruction received by command control 308 can be executed on all operands in a data stream, enabling OPU 300 to avoid the instruction fetch unit (IFU) associated with conventional processors. Control bus 310 may serve as an operator queue for one or more operators that are executed on the streams of tuples. ALU 304 may execute operators on operands (e.g., data streams of tuples) as the operands become available at input control 302, thereby enabling OPU 300 to maximize throughput in a self-synchronized manner.

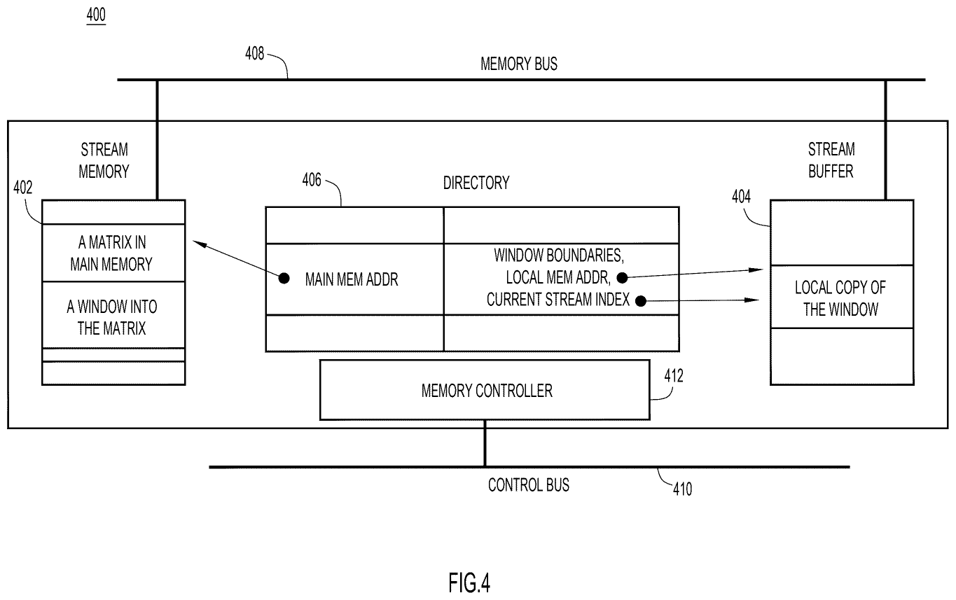

FIG. 4 is a block diagram of a memory system 400 for an operator processing unit according to an embodiment of the present invention. Memory system 400 may handle memory operations for one or more OPUs (e.g., OPU 300 as depicted and described with reference to FIG. 3). As depicted, memory system 400 includes a stream memory 402, a stream buffer 404, a directory 406, a memory bus 408, a control bus 410, and a memory controller 412.

Stream memory 402 may serve as a memory control that fetches data streams from another memory (e.g., via memory bus 408). Stream memory 402 may perform controller functions such as mapping multiple sections of byte-addressable data under the control of stream memory 402 to a particular data stream, while addressing any capacity and format requirements of the other memory from which the data is fetched. Stream memory 402 may identify a portion or “window” of a matrix stored in main memory from which a current stream is being fetched. Thus, stream memory 402 may only fetch portions of memory that are relevant for current operations.

Stream buffer 404 may serve as a user-addressable cache or an architected scratchpad buffer, meaning that software or a higher-level controller can specify the data that goes into stream buffer 404, how long the data is stored in buffer 404, and/or when the data is evicted or updated. Thus, stream buffer 404 may serve as a locally managed memory or scratchpad rather than following automatic caching policies. Stream buffer 404 may store certain data to manage latency, asynchrony, and bandwidth concerns. In particular, stream buffer 404 may manage the reuse of fetched data, may perform scatter or gather operations for latency reductions, and may perform sort operations, merge operations, hashing operations, and/or reduction operations. For a multidimensional dataset (e.g., a three-dimensional dataset, a four-dimensional dataset, etc.), stream buffer 404 may store a “subcube” or slice of data (e.g., values for a first dimension, first and second dimensions, etc.), which may be reused in various operations.

Directory 406 may store various metadata, including main memory addresses corresponding to the copies of data stored in stream memory 402. Directory 406 may store window boundaries (e.g., the start and end positions of windows in memory), local memory addresses in the stream buffer 404 in which a copy resides, and/or a current stream index or other state tracker to manage the process of streaming data.

Memory controller 412 may orchestrate read and/or write requests by interfacing with directory 406, stream memory 402, and/or stream buffer 404. To perform these functions, memory controller 412 may receive commands from control bus 410. Thus, a processor or other element may send commands to memory controller 412 to cause memory controller 412 to load a next window of data into stream memory 402 or commit data from stream memory 402 and/or stream buffer 404 back to a main memory (e.g., via memory bus 408).

Thus, memory system 400 may perform various operations, including organizing data, fetching data, and/or buffering data for use by one or more OPUs. In contrast to conventional memory management techniques, memory system 400 may perform read and/or write operations in terms of variable-length streams of data, rather than in fixed byes or cache lines. Whereas an OPU receives a command that involves processing of operands (e.g., applying a particular operator to tuples of a data stream), memory system 400 receives commands that cause particular streams of data to be fetched, etc. In some embodiments, memory system 400 can perform predicate filtering (e.g., fetching a data stream while omitting portions that are not requested), can perform sort operations, merge operations, and the like.

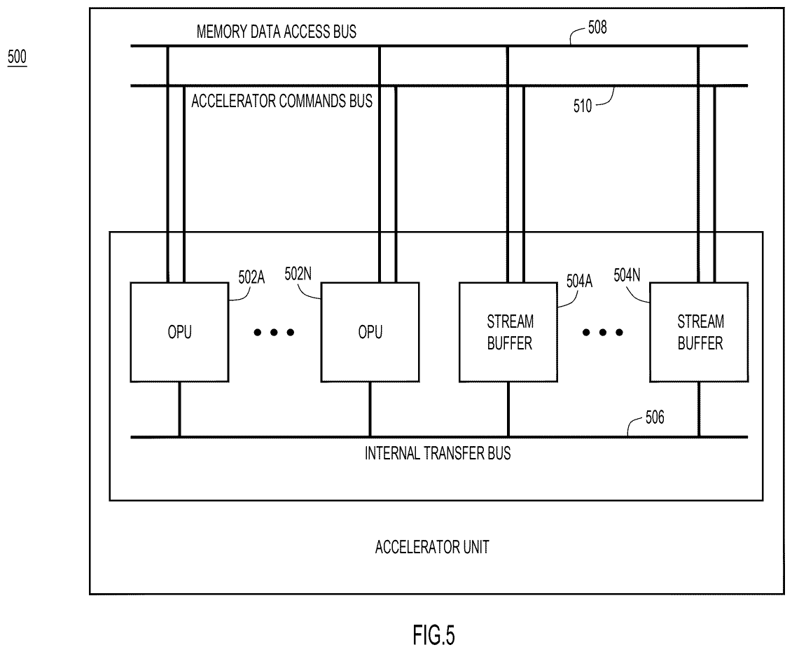

FIG. 5 is a block diagram of an operator processing unit (OPU) system 500 according to an embodiment of the present invention. As depicted, OPU system 500 includes a plurality of OPUs 502A-502N, a plurality of stream buffers 504A-504N, an internal transfer bus 506, a memory data access bus 508, and an accelerator commands bus 510. Each OPU 502A-502N may correspond to OPU 300, as depicted and described with reference to FIG. 3, and each stream buffer 504A-504N may correspond to stream buffer 404 as depicted and described with reference to FIG. 4. Accelerator commands bus 510 may correspond to control bus 310 of FIG. 3 and/or control bus 410 of FIG. 4. Memory data access bus 508 may correspond to memory bus 312 of FIG. 3 and/or memory bus 408 of FIG. 4. While not pictured in FIG. 5, other elements of the embodiments presented herein may be present, such as stream memory 402, etc.

In OPU system 500, OPUs 502A-502N are connected to each other to act as an accelerator for processing streams of tuples. The OPUs 502A-502N can be connected in series and/or in parallel such that the output of one OPU can be provided as input to another OPU. Thus, each OPU 502A-502N can execute a particular operator on a data stream, enabling multi-step computing tasks to be divided across the OPUs 502A-502N. In order to achieve this, data may be cascaded from one OPU to another OPU via internal transfer bus 506. In some embodiments, one or more of the OPUs 502A-502N are provided with multiple ALUs so that the input controller of an OPU can provide the OPU with a larger amount of input tuples, which can be processed simultaneously by the multiple ALUs.

The data streams that are processed by OPUs 502A-502N can be provided via memory data access bus 508, and operators can be provided via accelerator commands bus 510. Stream buffers 504A-504N can optionally buffer data streams that are repeatedly accessed during execution of a computing task; however, the input controllers for each OPU 502A 502N can alternatively obtain repeatedly-accessed tuples from either the stream buffers 504A-504N or from memory (e.g., via memory data access bus 508). Thus, suitable computing tasks (e.g., matrix processing tasks, graph processing tasks, database processing tasks, etc.) can be mapped to the OPUs 502A-502N so that different OPUs 502A-502N are instructed to execute different operators on input tuples, enabling the computing tasks to be more efficiently executed without necessitating a general-purpose processor to orchestrate the tasks.

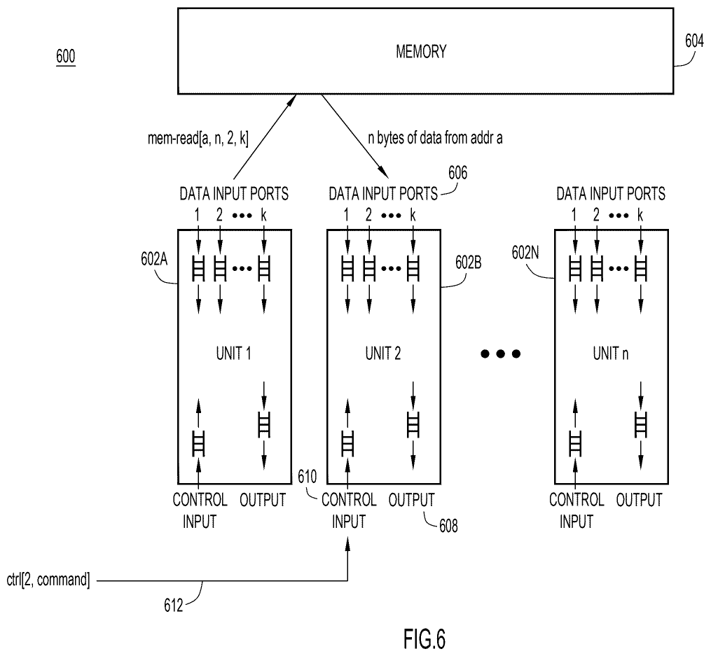

FIG. 6 is a block diagram of an operator processing unit (OPU) system 600 according to an embodiment of the present invention. As depicted, OPU system 600 includes a plurality of OPUs 602A-602N and a memory 604. Each OPU 602A-602N may correspond to the OPU 300 as depicted and described in FIG. 3, and the OPUs 602A-602N may be connected via a bus (not shown in FIG. 6), such as internal transfer bus 506 as depicted and described with reference to FIG. 5 and/or other busses.

OPU system 600 is configured to enable any OPU 602A-602N to cause data to be fetched from memory 604 and provided to any OPU 602A-602N. As depicted, each OPU 602A-602N includes a plurality of data input ports (e.g., data input ports 606 of OPU 602B), an output port (e.g., output port 608 of OPU 602B), and a control input (e.g., control input 610 of OPU 602B). In the depicted example, OPU 602A sends an instruction (“mem-read[a, n, 2, k]”) that indicates an address (“a”) in memory 604, a number of bytes to be fetched (“n”), an OPU to which to provide the data (“2”, i.e., “unit 2” which corresponds to OPU 602B), and a specific input port of the OPU to which to provide the data (port “k”). The data provided to an OPU may be processed by the OPU executing an operator that is received as an instruction (e.g., instruction 612). In the depicted example, the instruction “ctrl[2, command]” specifies the particular OPU (“2”, corresponding to OPU 602B) that is the destination for the operator (e.g., “command”). Thus, in the depicted example embodiment, OPU 602B executes a command on the n bytes of data fetched from address a, and outputs the results (e.g., at output port 608). The command may also indicate a destination for the output data, such as a particular port of a particular OPU 602A-602N. Thus resulting output data can be provided to memory 604 and/or to another OPU for subsequent processing.

For a given multi-operation processing job, OPU system 600 enables different operations to be distributed across the OPUs 602A-602N. For example, one OPU may scale tuples by a constant value, another OPU may compute dot products of two vectors received at different ports of the OPU, another OPU may perform matrix-vector multiplication, and the like. Each OPU 602A-602N may provide its results to another OPU 602A-602N so that ordered operations can be efficiently performed.

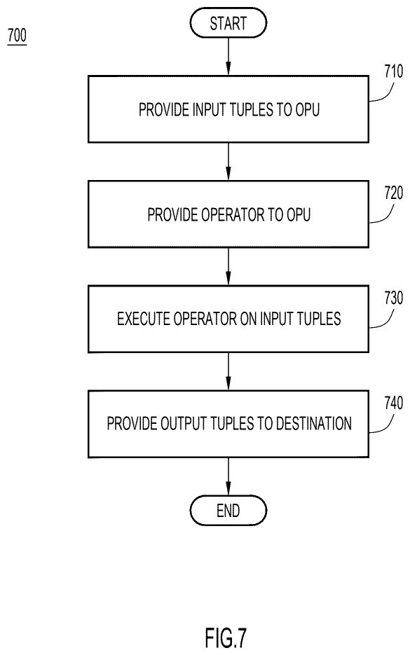

FIG. 7 is a flowchart of a method 700 for processing data using an operator processing unit (OPU) according to an embodiment of the present invention.

Input tuples are provided to an OPU at operation 710. Input tuples may be obtained from a memory that is configured to store variable-length streams of data (i.e., tuples). Each sequence of tuples may be obtained from a database (e.g., as column-major or row-major sequences), from a sparse matrix, from a directed acyclic graph, and the like. The input tuples may be provided to an input control (e.g., a buffer) of the OPU.

An operator is provided to the OPU at operation 720. The operator may define a particular operation to execute upon input tuples, such as scaling the values, multiplying a matrix by a vector, or performing other arithmetic operations on one or multiple sets of tuples. The operator may be received by a command control of the OPU via a control bus. In some embodiments, a general-purpose processor identifies particular computing tasks that are suitable for processing by an OPU, and issues instructions to cause the input tuples and operators to be provided to the OPU.

The operator is executed on the input tuples at operation 730. The ALU of an OPU receives the input tuples and executes the operator on the input tuples. Input tuples may be processed by the ALU on arrival at the input control rather than waiting on an entire sequence of tuples to be available. For example, if input tuples include index-value pairs (e.g., <index, value> tuples), and an operator adds two values together when their corresponding index numbers match, then the values may be summed whenever two matching index numbers become available rather than waiting on additional data to arrive.

The output tuples are provided to a destination at operation 740. Once the operator is executed on the input tuples, the resulting output tuples are provided to a destination, such as an output control of the OPU. The output tuples can be provided as input to another OPU, or provided to a memory such as a conventional memory or memory system 400, which is depicted and described with reference to FIG. 4.

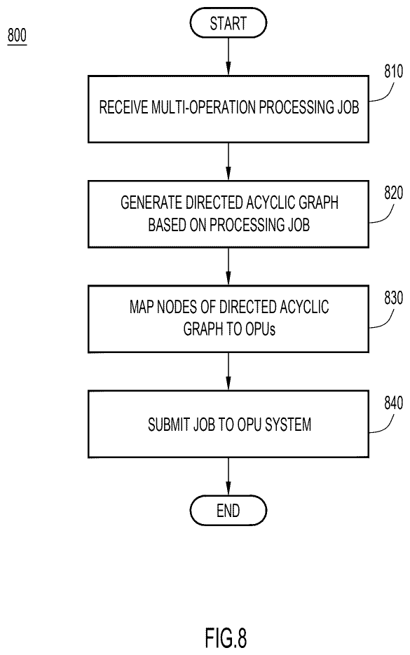

FIG. 8 is a flowchart of a method 800 for executing a processing job using an operator processing unit system according to an embodiment of the present invention.

A multi-operation processing job is received at operation 810. The processing job may include a plurality of different operations, and some of which may require performing in a particular order, as the output of one operation may be used as input for another operation. The processing job may involve processing data that is structured as one or more streams of tuples.

A directed acyclic graph (DAG) is generated based on the processing job at operation 820. The processing job may be decomposed into a DAG in which each operation is represented as a node, and the edges represent streams of tuples being passed between nodes. The DAG may include multiple splits and/or mergers, depending on the input and/or output requirements of each operation of the processing job.

Nodes of the DAG are mapped to OPUs at operation 830. Using a scheduler, the DAG is processed to map each node to a particular OPU of an OPU system having multiple OPUs (e.g., OPU system 500). Each edge is assigned a particular port number for an OPU that indicates which output streams of source nodes flow into input ports of destination nodes, and each operation is encoded into a syntax that is decipherable by the controller(s) of the OPUs.

The processing job is submitted to the OPU system at operation 840. A conventional processor, which may perform operations 810 and/or 820, may submit the operations to the OPU system and instruct the initial input tuples to be provided to the OPU system. Each node's operation may be assigned to the OPU to which the node is assigned, and the input tuples may be provided to a stream memory and/or stream buffer of the OPU system. Thus, a main processor or set of processors may schedule high-level operations and manage execution of the OPU system.

It will be appreciated that the embodiments described above and illustrated in the drawings represent only a few of the many ways of implementing embodiments for operator processing units.

The environment of the present invention embodiments may include any number of computer or other processing systems (e.g., any computing device, computing service, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., application code 200, application(s) 210, data stream module 220, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, distributed computing, and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the computing system. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., application data, data processed by OPU 300 or OPU system 500, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The application data, data processed by OPUs or OPU systems, and/or any other data may include any information arranged in any fashion, and may be configurable based on rules or other criteria to provide desired information to a user.

The present invention embodiments are not limited to the specific tasks or algorithms described above, but may be utilized for processing streaming tuple data.

The data may include any format of storing data and may include any data descriptive of databases, including metadata and indexes thereof. The data may be obtained via any techniques, and may be accessed over a network, fetched from local storage, provided via user input, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system comprising:
an operator unit (OPU) comprising:
an arithmetic logic unit (ALU) that is configured to natively process input tuples;
an operator queue associated with the ALU, wherein the operator queue stores one or more operators for the ALU to execute on the input tuples;
an operand buffer associated with the ALU, wherein the operand buffer stores the input tuples and provides the input tuples to the ALU for execution; and
an output buffer configured to store output tuples generated by the ALU executing the one or more operators on the input tuples.

2. The computer system of claim 1, wherein the input tuples comprise index-value pairs, and wherein the ALU executes a particular operator on sets of input tuples sharing a same index.

3. The computer system of claim 2, wherein the ALU is configured to execute the particular operator on a particular set of input tuples sharing the same index in response to the particular set of input tuples arriving at the operator queue without the ALU waiting on other input tuples.

4. The computer system of claim 1, wherein the input tuples comprise elements of a sparse matrix that are divided into three tuple sets for processing, the three tuple sets comprising a column begin position tuple set, a columns number tuple set, and a non-zero element values tuple set.

5. The computer system of claim 1, wherein the OPU includes a plurality of data input ports configured to receive the input tuples and a data output port configured to receive the output tuples.

6. The computer system of claim 1, wherein the input tuples are provided to the OPU by a stream memory that is configured to perform store operations for variable-length streams of tuples to arrive, and wherein the stream memory is configured to perform predicate filtering on fetched tuples.

7. The computer system of claim 1, wherein the ALU forwards the output tuples to an additional ALU for subsequent processing.

8. A computer-implemented method comprising:
providing input tuples to an operator unit (OPU), wherein the OPU comprises:
an arithmetic logic unit (ALU) that is configured to natively process the input tuples,
an operator queue associated with the ALU, wherein the operator queue stores an operator for the ALU to execute on the input tuples,
an operand buffer associated with the ALU, wherein the operand buffer stores the input tuples and provides the input tuples to the ALU for execution, and
an output buffer configured to store output tuples generated by the ALU executing the operator on the input tuples;
processing the input tuples by executing the operator using the ALU; and
providing the output tuples to the output buffer.

9. The computer-implemented method of claim 8, wherein the input tuples comprise index-value pairs, and wherein each ALU executes a particular operator on sets of input tuples sharing a same index.

10. The computer-implemented method of claim 9, wherein each ALU executes the particular operator on a particular set of input tuples sharing the same index in response to the particular set of input tuples arriving at the operator queue without the ALU waiting on other input tuples.

11. The computer-implemented method of claim 8, wherein the input tuples comprise elements of a sparse matrix that are divided into three tuple sets for processing, the three tuple sets comprising a column begin position tuple set, a columns number tuple set, and a non-zero element values tuple set.

12. The computer-implemented method of claim 8, wherein the OPU includes a plurality of data input ports configured to receive the input tuples and a data output port configured to receive the output tuples.

13. The computer-implemented method of claim 8, wherein the input tuples are provided to the OPU by a stream memory that is configured to perform store operations for variable-length streams of tuples to arrive, and wherein the stream memory is configured to perform predicate filtering on fetched tuples.

14. The computer-implemented method of claim 8, further comprising:
forwarding the output tuples to an additional ALU for subsequent processing.

15. A computer system comprising:
a plurality of operator units (OPUs), each OPU comprising:
an arithmetic logic unit (ALU) that is configured to natively process input tuples,
an operator queue associated with the ALU, wherein the operator queue stores one or more operators for the ALU to execute on the input tuples,
an operand buffer associated with the ALU, wherein the operand buffer stores the input tuples and provides the input tuples to the ALU for execution, and
an output buffer configured to store output tuples generated by the ALU executing the one or more operators on the input tuples,
wherein the output tuples of a first OPU of the plurality of OPUs are provided as the input tuples to a second OPU of the plurality of OPUs.

16. The computer system of claim 15, wherein the input tuples comprise index-value pairs, and wherein each ALU executes a particular operator on sets of input tuples sharing a same index.

17. The computer system of claim 16, wherein each ALU is configured to execute a particular operator on a particular set of input tuples sharing the same index in response to the particular set of input tuples arriving at the operator queue without the ALU waiting on other input tuples.

18. The computer system of claim 15, wherein the input tuples comprise elements of a sparse matrix that are divided into three tuple sets for processing, the three tuple sets comprising a column begin position tuple set, a columns number tuple set, and a non-zero element values tuple set.

19. The computer system of claim 15, wherein each OPU includes a plurality of data input ports configured to receive the input tuples and a data output port configured to receive the output tuples.

20. The computer system of claim 15, wherein the plurality of OPUs execute a computing task by generating a directed acyclic graph based on the computing task, wherein the directed acyclic graph comprises a plurality of nodes that are each associated with a particular operator, wherein a particular OPU is selected for each particular operator, and wherein each particular OPU processes input tuples using the particular operator assigned to that particular OPU.
